(19) United States
(12) Patent Application Publication
(10) Pub. No.: US 2011/0286588 A1
(43) Pub. Date: Nov. 24, 2011

(54) METHOD FOR PROVIDING PERSONALIZED INTERNET TELEPHONE SERVICE AND TERMINAL USING THE SAME

(76) Inventor: Sung Wan Kim, Gyeonggi-do (KR)

(21) Appl. No.: 13/145,923

(22) PCT Filed: Jan. 21, 2010
(86) PCT No.: PCT/KR10/00371

§ 371 Date: Aug. 2, 2011

(30) Foreign Application Priority Data
Jan. 22, 2009 (KR) 10-2009-0005646

(51) Int. Cl. H04W 4/24; H04M 11/00

(52) U.S. Cl. 379/91.01; 455/406

(57) ABSTRACT

Provided are a method for providing a personalized internet phone, and a terminal using the same. The method includes operations: (S10) of a user (20) using a terminal capable of internet connection to connect to a personalized internet phone service web server (10) and register for service, and store and set personal information in databases (11 and 12) of the personalized internet phone service web server (10); (S20) of the user (20) using a wired/wireless internet phone terminal (21) of an internet phone service provider being used, to connect to the personalized internet phone service web server (10); (S30) of using the wired/wireless internet phone terminal (21) to perform personal authentication and select a billing method, on a displayed screen provided by the personalized internet phone service web server (10); (S40) of, following the personal authentication and billing method selection, using the wired/wireless internet phone terminal (21) to call a phone number from a personally set phone number directory stored in the personal phone number directory storage database (12) of the personalized internet phone service web server (10) and make a phone call to a counterpart (30), or make a phone call using a phone number additionally provided by the personalized internet phone service web server (10); and (S50) of, when a call is made to a new phone number not stored in the personal phone number directory storage database (12), storing call details and the new phone number in the personal phone number directory storage database (12), and then ending the use of the wired/wireless internet phone terminal (21). Accordingly, an internet connecting member provided on a terminal may be used to connect to the personalized internet phone service web server and call a phone number list stored in the user's mobile phone terminal directly from a personal phone number directory storage database, or a list of phone numbers may be received from an additionally provided phone number directory storage database by business type in an area of interest or the current area which is provided by the web server, and the called or provided phone number may be used to make a call. Therefore, a wired/wireless internet phone terminal capable of being used for internet calling with an existing internet phone service provider may be used to connect to the personalized internet phone service web server and make the searching and calling of a phone number to be called as easy as when using the user's own mobile phone terminal, such that wired/wireless internet phone terminals may be popularized.

### TECHNICAL FIELD

The present invention relates to a method for providing personalized internet phone service and a terminal using the same, and more particularly, to a method for providing personalized internet phone service that uses a wired/wireless internet phone terminal to call a phone number stored in a personalized internet phone service web server, or for making a call using a phone number provided by the web server, and to a terminal using the method.

### BACKGROUND ART

An internet telephone is a system or service that transmits and receives audio signals via the internet so that it can be used like a typical telephone, and is also referred to as an internet phone or VOIP telephone.

After Vocal Tech, a US venture company, developed a voice communication system using a microphone and speaker connected to a personal computer (PC) in 1995, the concept of internet telephony became popular and may now be categorized into internet phone methods between a PC and PC, a PC and phone, and a phone and phone.

However, in order to converse with a counterpart with typical internet phone methods, a phone number that is to be used must first be searched from the numbers stored in one's mobile phone terminal and then input into an internet telephone, or a name or title to be searched in a phone directory or on the internet is first searched and then the searched phone number is input into an internet phone terminal. Thus, phone number searching is inconvenient and takes a lot of time.

### DETAILED DESCRIPTION

### Technical Problems

The present invention provides a method for providing a personalized internet phone service and a terminal using the same, wherein when a user registers as a member in a personalized internet phone service web server and stores a phone number list in a currently used mobile phone in a database of the web server, and then makes a call using a terminal (an internet phone terminal in the form of a portable phone, an internet phone terminal in the form of a typical home or office phone, an internet phone terminal in the form of a PDA, an internet terminal in the form of a public telephone, or an internet phone terminal in the form of a computer employing an internet phone service program) capable of being used for an internet phone service provided by an internet phone company currently being used, an internet connecting member provided on a terminal capable of the internet phone service may be used to connect to the personalized internet phone service web server and call a phone number list stored in the user's mobile phone terminal, or a list of phone numbers may be received by business type in an area of interest or the current area which is provided by the web server, and the called or provided phone number may be used to make a call.

### Technical Solutions

To achieve the above-mentioned objectives, the present invention provides methods of providing personalized internet phone service, including operations: of a user using a terminal capable of internet connection to connect to a personalized internet phone service web server and register for service, and store and set personal information in databases and of the personalized internet phone service web server; of the user using a wired/wireless internet phone terminal of an internet phone service provider being used, to connect to the personalized internet phone service web server; of using the wired/wireless internet phone terminal to perform personal authentication and select a billing method, on a displayed screen provided by the personalized internet phone service web server; of, following the personal authentication and billing method selection, using the wired/wireless internet phone terminal to call a phone number from a personally set phone number directory stored in the personal phone number directory storage database of the personalized internet phone service web server and make a phone call to a counterpart, or make a phone call using a phone number additionally provided by the personalized internet phone service web server; and of, when a call is made to a new phone number not stored in the personal phone number directory storage database, storing call details and the new phone number in the personal phone number directory storage database, and then ending the use of the wired/wireless internet phone terminal.

In another aspect of the invention, operation S10 includes operations: of the user, after using the terminal capable of internet connection to connect to the personalized internet phone service web server and perform the personal authentication and then input the personal authentication information to register for the service, storing and setting the information in the personal information storage database; of the user, after the registration for service, storing a phone number list stored in a currently used mobile phone terminal, in the personal phone number storage database; of setting the phone number additionally received and a phone number provided sequence, when using the personalized internet phone service web server service; of setting a personal authentication method of the user that will use the wired/wireless internet phone terminal; and of registering a payment method for a phone bill arising from the use of the wired/wireless internet phone terminal.

In another aspect of the invention, operation S12 of storing the phone number stored in the mobile phone terminal in the personalized phone number directory storage database includes an automatic storage method or a manual storage method, wherein in the automatic storage method, an automatic storage application provided by the personalized internet phone service web server may be set using a text message and wireless internet in the mobile phone terminal of the user, and then wireless internet is used to automatically store the phone numbers stored in the mobile phone terminal in the personal phone number directory storage database at regular time intervals, and in the manual storage method, one of the following methods is selected and used, the methods including: connecting a computer communication terminal capable of wired/wireless internet connection to the personalized internet phone service web server, through a connector to the mobile phone terminal of the user, and storing the phone number in the personal phone number directory storage database; activating the application set in the mobile phone terminal of the user, provided by the personalized internet phone service web server, with a button, to store the phone number through wireless internet in the personal phone number directory storage database; and using the mobile phone terminal of the user capable of wireless internet to directly connect to the personalized internet phone service web server and store the phone number in the personal phone number directory storage database.

In still another aspect of the invention, the additionally provided phone number in operation S13 is selected and set by the wired/wireless internet phone terminal of the user, from among a provided phone number according to an area of interest to the user or a current location of the user which are stored in an additionally provided phone number directory storage database of the personalized internet phone service web server, and a provided phone number of a venue conducting a phone rate discount and gift event; and the phone number providing sequence may be selected and set by the wired/wireless internet phone terminal of the user, from among a free phone number sequence according to a receiver billing policy, a free phone number sequence according to a billing policy of an internet phone service provider to which the wired/wireless phone terminal used by the user is registered, and a phone number sequence of an inexpensive telecom rate.

In even another aspect of the invention, in the personal authentication method of operation S14, when required information is input for an authentication method using an ID (user mobile phone number/text/numbers) and a set security number, or for an authentication method using text messaging of an authentication number to the mobile phone of the user, or for an authentication method using a digital certificate and digital certificate security number of the user, or for an authentication method using a credit card and credit card security number of the user, one of the authentication methods may be selected as a standard authentication method.

In yet another aspect of the invention, the payment method in operation S15 is selected as a standard payment method from among a method of billing to a mobile phone bill or telecom bill of the user, a method of billing to a credit card bill of the user, and a method of issuing a bill by mail to the user or automatic payment.

In further another aspect of the invention, in operation S20, the connection is made to the personalized internet phone service web server through wired/wireless internet, by means of: directly clicking an internet phone service execute menu button provided in a button format on an outside of the wired/wireless internet phone terminal or an execute menu button having a number code provided in a touch screen format on a screen of the wired/wireless internet phone terminal that selectively uses one from among a home phone, office phone, internet public phone, and a mobile communication terminal having an application installed therein provided by the personalized internet phone service web server; or inputting a number code corresponding to one provided on the screen of the wired/wireless internet phone terminal, through an external number pad on a phone.

In still further aspect of the invention, in operation S30, text/number buttons in a touch screen format provided on a screen or external text/number buttons on the wired/wireless internet phone terminal that connects to and uses the personalized internet phone service web server is clicked to select a standard authentication method set upon registration or another authentication number and log in, a standard payment method for the phone bill of the internet phone to be used, or another payment method may be selected, and the payment method may be billed as a standard billing for the wired/wireless internet phone terminal being used when the billing method is not selected.

In even further aspect of the invention, operation S40 includes operations: of activating, in a display screen of the wired/wireless internet phone terminal, a ‘personal phone number call service’ menu for calling a phone number list stored by a user upon registration, from the personal phone number directory storage database, and an ‘additional service’ menu provided by an additionally provided phone number directory storage database for phone numbers corresponding to conditions set by the user upon registration to be additionally received; of using buttons of the wired/wireless internet phone terminal to select a menu to be received from among the ‘personal phone number call service’ menu and the ‘additional service’ menu, to call a personal phone number or receive an additional service phone number; of activating the group menu initially stored in the mobile phone terminal of the user, when the ‘personal phone number call service’ is selected, and activating a group menu by company for an area of interest or the current location, when the ‘additional service’ is selected; of arranging phone numbers of corresponding counterparts when the ‘personal phone number call service’ group is selected, in a stored sequence in the mobile phone terminal of the user, and arranging phone numbers of corresponding businesses when the ‘additional service’ group is selected, in an order of priority from free calling and least expensive telecom rates from among a recipient billing policy and an internet phone service provider billing policy under which the wired/wireless internet phone terminal used by the user is registered; and of connecting a call after selection of a phone number to be called from among a phone number called by means of the ‘personal phone number call service’ and a phone number provided by the ‘additional service’, and connecting a call by selecting one from among a method for connecting a call by the user searching for a phone number to call through sub categories in a tree method, through a menu having a number code configured on the screen of the wired/wireless internet phone terminal with external number buttons, and a method for connecting a call by searching for a number of a corresponding group or counterpart by the user, in the search screen of the wired/wireless internet phone terminal, with text and partial numbers of phone numbers thereof.

In yet further aspect of the invention, in operation S50, before and after a call connection is made for a new number not called or provided by the personal phone number directory storage database of the personalized internet phone service web server, a ‘save new’ menu button provided on a screen of the wired/wireless internet phone terminal may be activated, and the new number may be newly stored in the phone number list stored in the personal phone number directory storage database of the personalized internet phone service web server.

In much further aspect of the invention, whenever use of the wired/wireless internet phone terminal is ended, a time a call was made by the user, a number with which the call was connected, a call time, a call rate, and a call rate billing method may be automatically stored in the personal information storage database of the personalized internet phone service web server, the details of use may be automatically sent by e-mail to an e-mail address entered when the user registered in the personalized internet phone service web server or automatically sent by text message to the mobile phone terminal of the user, and the user may be able to check the details of use by logging into the personalized internet phone service web server.

In still much further aspect of the invention, when the wired/wireless internet phone terminal is used to log into the personalized internet phone service web server, or when after a certain time has elapsed since the wired/wireless internet phone terminal was used to make a phone call and there is no subsequent input signal through a button, or when the user lowers a receiver or selects a forcibly ending menu button in the wired/wireless phone terminal, the personalized internet phone service web server may perceive an end signal by the user and automatically log out.

Embodiments of the present invention also provide personalized internet phone services provided through any one of the method above.

### Advantageous Effect of Invention

The present invention provides a method for providing a personalized internet phone service and a terminal using the same, wherein when a user registers as a member in a personalized internet phone service web server and automatically or manually stores a phone number list in a currently used mobile phone in the web server, and then makes a call using a terminal capable of being used for an internet phone service provided by an internet phone company currently being used, an internet connecting member provided on a terminal may be used to connect to the personalized internet phone service web server and call a phone number list stored in the user's mobile phone terminal directly from a personal phone number directory storage database, or a list of phone numbers may be received from an additionally provided phone number directory storage database by business type in an area of interest or the current area which is provided by the web server, and the called or provided phone number may be used to make a call. Therefore, a wired/wireless internet phone terminal capable of being used for internet calling with an existing internet phone service provider may be used to connect to the personalized internet phone service web server and make the searching and calling of a phone number to be called as easy as when using the user's own mobile phone terminal, such that wired/wireless internet phone terminals may be popularized.

### BRIEF DESCRIPTION OF DRAWINGS

FIG. 1 is a flowchart of a method for providing a personalized internet phone service according to an embodiment of the present invention;

FIG. 2 is a flowchart of a service application process on a personalized internet phone service web server according to an embodiment of the present invention;

FIG. 3 is a flowchart of a process for calling personally set phone numbers and making a call with an additionally provided phone number according to an embodiment of the present invention;

FIG. 4 is a configurative view showing the use of a personalized internet phone service according to an embodiment of the present invention; and

FIGS. 5 and 6 are views showing phone number search processes using wired/wireless internet phone terminals according to an embodiment of the present invention.

### BEST MODES FOR PRACTICING INVENTION

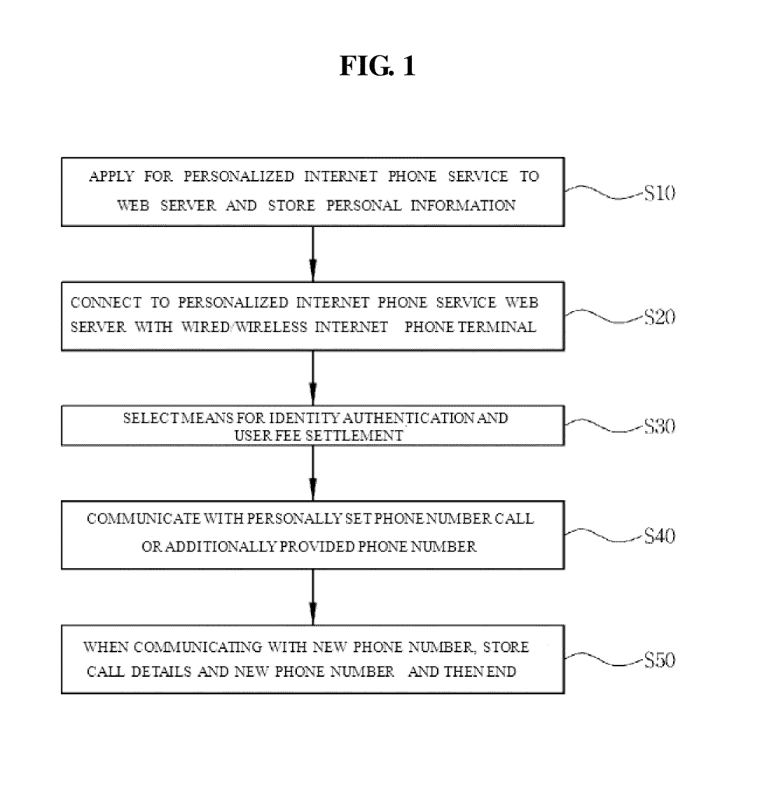

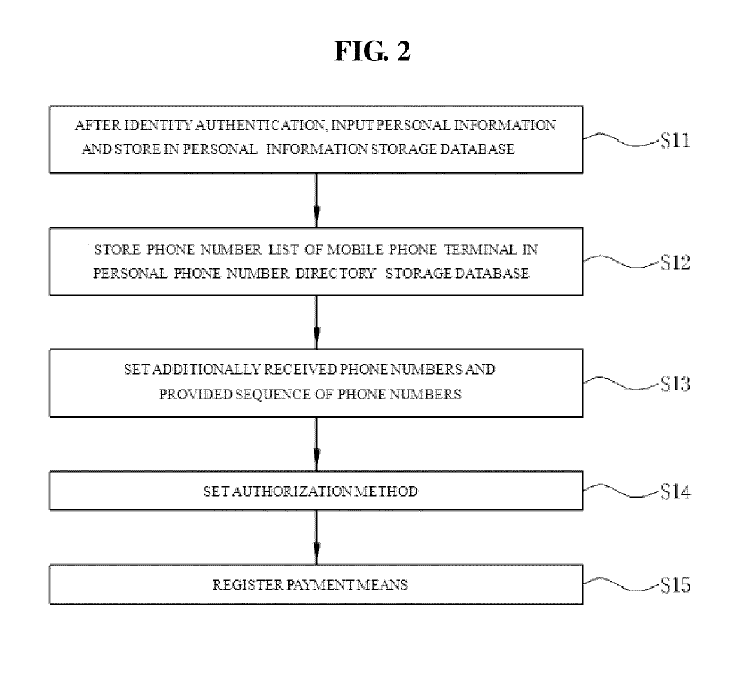

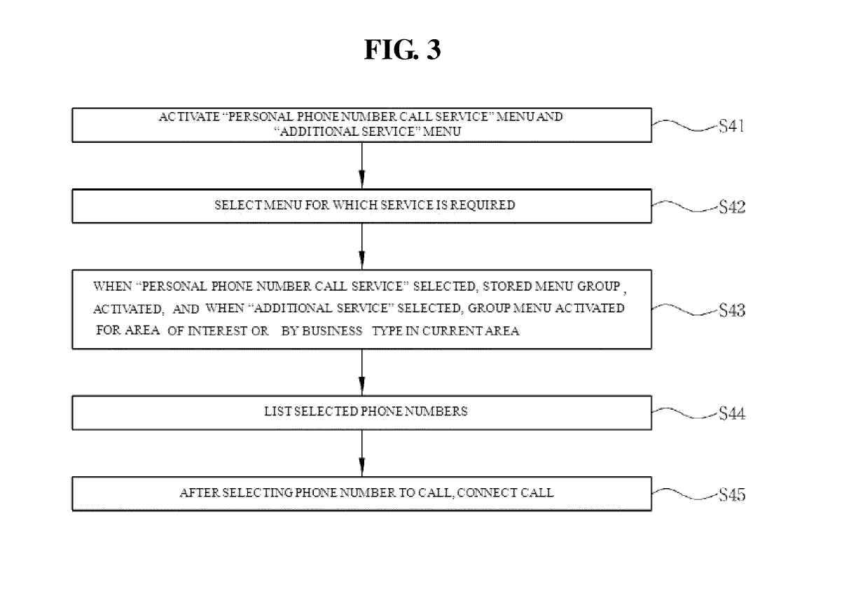

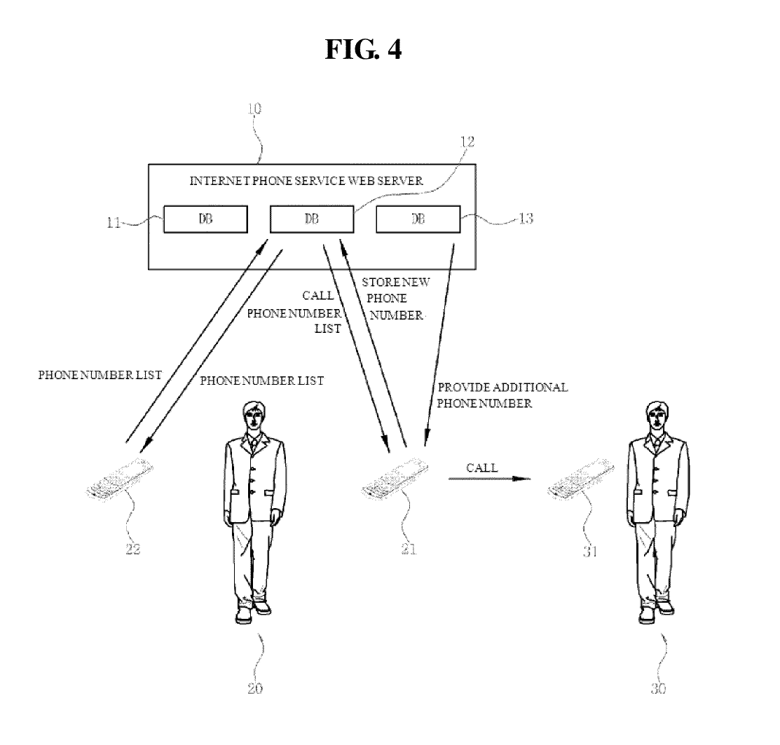

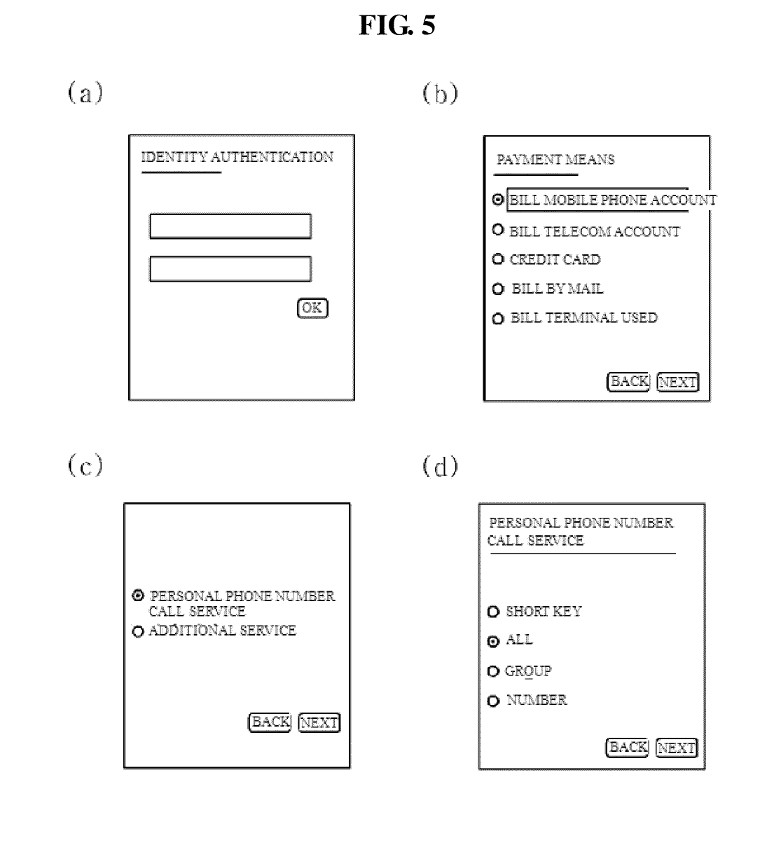

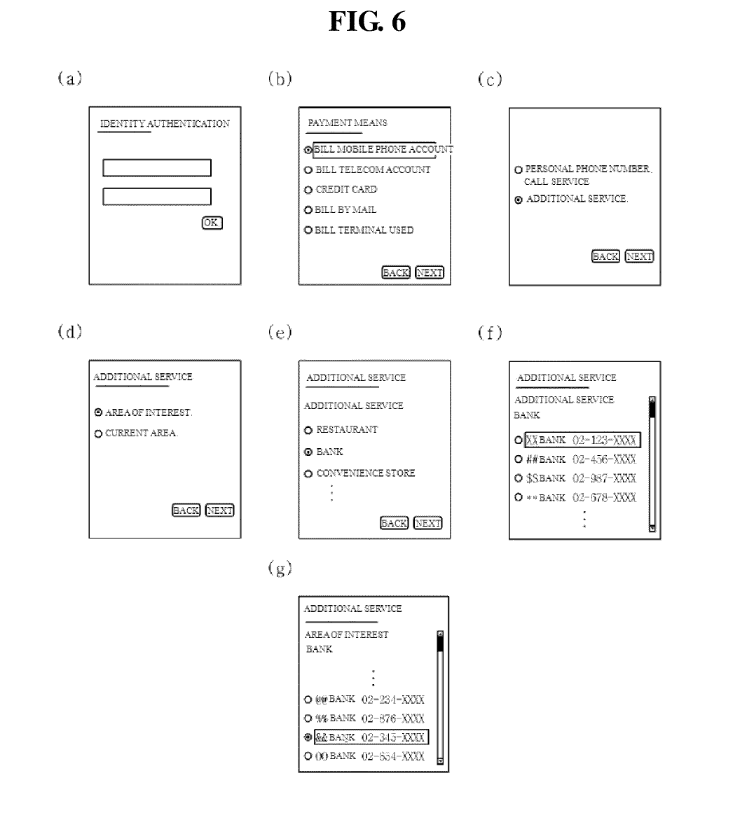

FIG. 1 is a flowchart of a method for providing a personalized internet phone service according to an embodiment of the present invention, FIG. 2 is a flowchart of a service application process on a personalized internet phone service web server according to an embodiment of the present invention, FIG. 3 is a flowchart of a process for calling personally set phone numbers and making a call with an additionally provided phone number according to an embodiment of the present invention, FIG. 4 is a configurative view showing the use of a personalized internet phone service according to an embodiment of the present invention, and FIGS. 5 and 6 are views showing phone number search processes using wired/wireless internet phone terminals according to an embodiment of the present invention.

Referring to the drawings, a detailed description of the configurative elements will be provided below.

FIG. 1 is a flowchart of a method for providing a personalized internet phone service according to an embodiment of the present invention, where the method may include operations: S10 of a user 20 using a terminal capable of internet connection to connect to a personalized internet phone service web server 10 and register for service, and store and set personal information in databases 11 and 12 of the personalized internet phone service web server 10; S20 of the user 20 using a wired/wireless internet phone terminal 21 of an internet phone service provider being used, to connect to the personalized internet phone service web server 10; S30 of using the wired/wireless internet phone terminal 21 to perform personal authentication and select a billing method, on a displayed screen provided by the personalized internet phone service web server 10; S40 of, following the personal authentication and billing method selection, using the wired/wireless internet phone terminal 21 to call a phone number from a personally set phone number directory stored in the personal phone number directory storage database 12 of the personalized internet phone service web server 10 and make a phone call to a counterpart 30, or make a phone call using a phone number additionally provided by the personalized internet phone service web server 10; and S50 of, when a call is made to a new phone number not stored in the personal phone number directory storage database 12, storing call details and the new phone number in the personal phone number directory storage database 12, and then ending the use of the wired/wireless internet phone terminal 21.

Operation S10 as shown in FIG. 2 may include operations: S11 of the user 20, after using the terminal capable of internet connection to connect to the personalized internet phone service web server 10 and perform the personal authentication and then input the personal authentication information to register for the service, storing and setting the information in the personal information storage database 11; S12 of the user 20, after the registration for service, storing a phone number list stored in a currently used mobile phone terminal 22, in the personal phone number storage database 12; S13 of setting the phone number additionally received and a phone number provided sequence, when using the personalized internet phone service web server 10 service; S14 of setting a personal authentication method of the user 20 that will use the wired/wireless internet phone terminal 21; and S15 of registering a payment method for a phone bill arising from the use of the wired/wireless internet phone terminal 21.

Operation S12 of storing the phone number stored in the mobile phone terminal 22 in the personalized phone number directory storage database 12 may include an automatic storage method or a manual storage method.

In the automatic storage method, an automatic storage application provided by the personalized internet phone service web server 10 may be set using a text message and wireless internet in the mobile phone terminal 22 of the user 20, and then wireless internet may be used to automatically store the phone numbers stored in the mobile phone terminal 22 in the personal phone number directory storage database 12 at regular time intervals.

In the manual storage method, one of the following methods may be selected and used, the methods including: connecting a computer communication terminal capable of wired/wireless internet connection to the personalized internet phone service web server 10, through a connector to the mobile phone terminal 22 of the user 20, and storing the phone number in the personal phone number directory storage database 12; activating the application set in the mobile phone terminal 22 of the user 20, provided by the personalized internet phone service web server 10, with a button, to store the phone number through wireless internet in the personal phone number directory storage database 12; and using the mobile phone terminal 22 of the user 20 capable of wireless internet to directly connect to the personalized internet phone service web server 10 and store the phone number in the personal phone number directory storage database 12.

Conversely, the phone number list stored in the personal phone number directory storage database 12 of the personalized internet phone service web server 10 may also be transferred to the mobile phone terminal 22 of the user 20.

The additionally provided phone number in operation S13 may be selected and set by the wired/wireless internet phone terminal 21 of the user 20, from among a provided phone number according to an area of interest to the user 20 or a current location of the user 20 which are stored in an additionally provided phone number directory storage database 13 of the personalized internet phone service web server 10, and a provided phone number of a venue conducting a phone rate discount and gift event; and the phone number providing sequence is selected and set by the wired/wireless internet phone terminal 21 of the user 20, from among a free phone number sequence according to a receiver billing policy, a free phone number sequence according to a billing policy of an internet phone service provider to which the wired/wireless phone terminal 21 used by the user 20 is registered, and a phone number sequence of an inexpensive telecom rate.

In the personal authentication method of operation S14, when required information is input for an authentication method using an ID (user mobile phone number/text/numbers) and a set security number, or for an authentication method using text messaging of an authentication number to the mobile phone of the user 20, or for an authentication method using a digital certificate and digital certificate security number of the user 20, or for an authentication method using a credit card and credit card security number of the user 20, one of the authentication methods may be selected as a standard authentication method.

The payment method in operation S15 may be selected as a standard payment method from among a method of billing to a mobile phone bill or telecom bill of the user 20, a method of billing to a credit card bill of the user 20, and a method of issuing a bill by mail to the user 20 or automatic payment.

In operation S20, the connection may be made to the personalized internet phone service web server 10 through wired/wireless internet, by means of: directly clicking an internet phone service execute menu button provided in a button format on an outside of the wired/wireless internet phone terminal 21 or an execute menu button having a number code provided in a touch screen format on a screen of the wired/wireless internet phone terminal 21 that selectively uses one from among a home phone, office phone, internet public phone, and a mobile communication terminal having an application installed therein provided by the personalized internet phone service web server 10; or inputting a number code corresponding to one provided on the screen of the wired/wireless internet phone terminal 21, through an external number pad on a phone.

In operation S30, text/number buttons in a touch screen format provided on a screen or external text/number buttons on the wired/wireless internet phone terminal 21 that connects to and uses the personalized internet phone service web server 10 may be clicked to select a standard authentication method set upon registration or another authentication number and log in, a standard payment method for the phone bill of the internet phone to be used, or another payment method is selected, and the payment method is billed as a standard billing for the wired/wireless internet phone terminal 21 being used when the billing method is not selected.

However, a payment method must be selected on a public phone-type internet phone (internet public phone).

Operation S40 as shown in FIG. 3 may include operations: S41 of activating, in a display screen of the wired/wireless internet phone terminal 21, a ‘personal phone number call service’ menu for calling a phone number list stored by a user 20 upon registration, from the personal phone number directory storage database 12, and an ‘additional service’ menu provided by an additionally provided phone number directory storage database 13 for phone numbers corresponding to conditions set by the user 20 upon registration to be additionally received; S42 of using buttons of the wired/wireless internet phone terminal 21 to select a menu to be received from among the ‘personal phone number call service’ menu and the ‘additional service’ menu, to call a personal phone number or receive an additional service phone number; S43 of activating the group menu initially stored in the mobile phone terminal 22 of the user 20, when the ‘personal phone number call service’ is selected, and activating a group menu by company for an area of interest or the current location, when the ‘additional service’ is selected; S44 of arranging phone numbers of corresponding counterparts when the ‘personal phone number call service’ group is selected, in a stored sequence in the mobile phone terminal 22 of the user 20, and arranging phone numbers of corresponding businesses when the ‘additional service’ group is selected, in an order of priority from free calling and least expensive telecom rates from among a recipient billing policy and an internet phone service provider billing policy under which the wired/wireless internet phone terminal 21 used by the user 20 is registered; and S45 of connecting a call after selection of a phone number to be called from among a phone number called by means of the ‘personal phone number call service’ and a phone number provided by the ‘additional service’, and connecting a call by selecting one from among a method for connecting a call by the user 20 searching for a phone number to call through sub categories in a tree method, through a menu having a number code configured on the screen of the wired/wireless internet phone terminal 21 with external number buttons, and a method for connecting a call by searching for a number of a corresponding group or counterpart 30 by the user 20, in the search screen of the wired/wireless internet phone terminal 21, with text and partial numbers of phone numbers thereof.

In operation S50, before and after a call connection is made for a new number not called or provided by the personal phone number directory storage database 12 of the personalized internet phone service web server 10, a ‘save new’ menu button provided on a screen of the wired/wireless internet phone terminal 21 may be activated, and the new number may be newly stored in the phone number list stored in the personal phone number directory storage database 12 of the personalized internet phone service web server 10.

The phone number called by the personal phone number directory storage database 12 of the personalized internet phone service web server 10 is not stored in the wired/wireless internet phone terminal 21 being used, and the phone number is simply called or received to be used to make a call.

Whenever use of the wired/wireless internet phone terminal 21 is ended, a time a call was made by the user 20, a number with which the call was connected, a call time, a call rate, and a call rate billing method may be automatically stored in the personal information storage database 11 of the personalized internet phone service web server 10, the details of use are automatically sent by e-mail to an e-mail address entered when the user 20 registered in the personalized internet phone service web server 10 or automatically sent by text message to the mobile phone terminal 22 of the user 20, and the user 20 is able to check the details of use by logging into the personalized internet phone service web server 10.

When the wired/wireless internet phone terminal 21 is used to log into the personalized internet phone service web server 10, or when after a certain time has elapsed since the wired/wireless internet phone terminal 21 was used to make a phone call and there is no subsequent input signal through a button, or when the user 20 lowers a receiver or selects a forcibly ending menu button in the wired/wireless phone terminal 21, the personalized internet phone service web server 10 perceives an end signal by the user 20 and may automatically log out.

The wired/wireless internet phone terminal 21 may include a speech calling member that connects directly to a computer terminal.

FIG. 4 is a configurative view showing the use of a personalized internet phone service according to an embodiment of the present invention, the personalized internet phone service web server 10 including a personal information storage database 11, a personal phone number directory storage database 12, and an additionally provided phone number directory storage database 13. A user 20 connects to the personalized internet phone service web server 10 through a wired/wireless terminal capable of internet connection, registers for service, and stores personal information in the personal information storage database 11. A phone number list in a mobile phone terminal 22 being used may be stored in the personal phone number directory storage database 12, or a phone number list may be stored from the personal phone number directory storage database 12 to the mobile phone terminal 22. A phone number list from the personal phone number directory storage database 12 may be called by a wired/wireless internet phone terminal 21, or an additional phone number may be received from the additionally provided phone number directory storage database 13, in order to make a call to a phone terminal 31 of a counterpart 30. When a call is made to a new phone number not stored in the personal phone number directory storage database 12, the new phone number may be stored in the personal phone number directory storage database 12.

FIGS. 5 and 6 are views showing phone number search processes using wired/wireless internet phone terminals 21 according to an embodiment of the present invention. Referring to FIGS. 5A and 6A, after a wired/wireless phone terminal 21 is used to connect to the personalized internet phone service web server 10 by using an authentication method using an ID (user mobile phone number/text/numbers) and a set security number, or an authentication method using text messaging of an authentication number to the mobile phone of the user 20, or an authentication method using a digital certificate and digital certificate security number of the user 20, or an authentication method using a credit card and credit card security number of the user 20, as shown in FIGS. 5B and 6B, a standard payment method chosen upon service registrations, ‘charge to mobile phone bill’ may be used as-is, or up/down buttons provided on the wired/wireless internet phone terminal 21 may be used to select another payment method.

After selecting the payment method, one of the ‘personal phone number call service’ menu and ‘additional service’ menu is selected. FIG. 5C shows an embodiment in which the ‘personal phone number call service’ menu is selected, and FIG. 5D shows an embodiment in which the ‘all’ menu, that is a sub menu of the ‘personal phone number call’ menu, is selected. When search results appear as shown in FIG. 5E, the up/down buttons provided on the wired/wireless internet phone terminal 21 may be used as shown in FIG. 5F to search for a name of a counterpart with whom one wishes to speak and to call that person.

After the payment method is selected, in the selecting of one of the ‘personal phone number call service’ menu or the ‘additional service’ menu, FIG. 6C shows an embodiment in which the ‘additional service’ menu is selected, and FIG. 6D is a view showing the selection of the ‘area of interest’ menu that is a sub menu of the ‘additional service’ menu. When a sub menu of the ‘area of interest’ menu is displayed as shown in FIG. 6E, when the ‘bank’ menu is selected from among desired menus, a search result such as that shown in FIG. 6F is displayed, and up/down buttons provided on the wired/wireless internet phone terminal 21 may be used as shown in FIG. 6G to search for and call a name or title of a party with whom one wishes to speak.

FIGS. 5 and 6 show exemplary embodiments of methods for going to sub categories using tree methodology to search phone numbers for calling, and as in operation S45, after the selection of personal authentication and payment method, text and a portion of numbers for the corresponding phone number of a group or counterpart 30 that a user 20 wants to search may be directly searched in a search screen that is displayed, in order to make a call to that number.

The present invention provides the above described wired/wireless internet phone terminal 21 capable of being used to make a phone call with the personalized internet phone service web server 10, and the wired/wireless internet phone terminal 21 includes all communication terminals capable of internet connection, which include internet phones, general household phones, office-type phones, public phone-type phones, mobile phone-type phones, navigation or PMP-type phones, wristwatch-type phones, etc., and devices with earphones and microphones that may be directly connected to a computer terminal for voice communication. Internet connection may be provided through a touch-screen method via a display screen and input selecting member, or through a conventional button click-type method as an input selecting member, and a liquid crystal display for a display screen.

With a personalized internet phone service providing method and terminal using the same according to the present invention, after a user 20 registers in a personalized internet phone service web server 10, automatically or manually stores a phone number list in a mobile phone terminal 22 currently being used, in a personal phone number directory storage database 12 of the web server, and then uses a wired/wireless internet phone terminal 21 capable of internet phone service with a currently used internet phone service provider (such as an internet-capable wired/wireless internet phone terminal 21 or general mobile phone, home phone, office phone, PDA, public phone, etc.) to make a phone call, an internet connecting member provided on the terminal may be used to connect to the personalized internet phone service web server 10 and call a phone number list stored in one's own mobile phone terminal 22, or receive a phone number list by company, corresponding to an area of interest or a current area, from the web server, and use the called or provided phone number to make a call.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A method for providing a personalized internet phone service, the method comprising operations:
(S10) of a user (20) using a terminal capable of internet connection to connect to a personalized internet phone service web server (10) and register for service, and store and set personal information in databases (11 and 12) of the personalized internet phone service web server (10);
(S20) of the user (20) using a wired/wireless internet phone terminal (21) of an internet phone service provider being used, to connect to the personalized internet phone service web server (10);
(S30) of using the wired/wireless internet phone terminal (21) to perform personal authentication and select a billing method, on a displayed screen provided by the personalized internet phone service web server (10);
(S40) of, following the personal authentication and billing method selection, using the wired/wireless internet phone terminal (21) to call a phone number from a personally set phone number directory stored in the personal phone number directory storage database (12) of the personalized internet phone service web server (10) and make a phone call to a counterpart (30), or make a phone call using a phone number additionally provided by the personalized internet phone service web server (10); and
(S50) of, when a call is made to a new phone number not stored in the personal phone number directory storage database (12), storing call details and the new phone number in the personal phone number directory storage database (12), and then ending the use of the wired/wireless internet phone terminal (21).

2. The method of claim 1, wherein operation S10 comprises operations:
(S11) of the user (20), after using the terminal capable of internet connection to connect to the personalized internet phone service web server (10) and perform the personal authentication and then input the personal authentication information to register for the service, storing and setting the information in the personal information storage database (11);
(S12) of the user (20), after the registration for service, storing a phone number list stored in a currently used mobile phone terminal (22), in the personal phone number storage database (12);
(S13) of setting the phone number additionally received and a phone number provided sequence, when using the personalized internet phone service web server (10) service;
(S14) of setting a personal authentication method of the user (20) that will use the wired/wireless internet phone terminal (21); and
(S15) of registering a payment method for a phone bill arising from the use of the wired/wireless internet phone terminal (21).

3. The method of claim 2, wherein operation S12 of storing the phone number stored in the mobile phone terminal (22) in the personalized phone number directory storage database (12) comprises an automatic storage method or a manual storage method, wherein
in the automatic storage method, an automatic storage application provided by the personalized internet phone service web server (10) is set using a text message and wireless internet in the mobile phone terminal (22) of the user (20), and then wireless internet is used to automatically store the phone numbers stored in the mobile phone terminal (22) in the personal phone number directory storage database (12) at regular time intervals, and
in the manual storage method, one of the following methods is selected and used, the methods comprising: connecting a computer communication terminal capable of wired/wireless internet connection to the personalized internet phone service web server (10), through a connector to the mobile phone terminal (22) of the user (20), and storing the phone number in the personal phone number directory storage database (12); activating the application set in the mobile phone terminal (22) of the user (20), provided by the personalized internet phone service web server (10), with a button, to store the phone number through wireless internet in the personal phone number directory storage database (12); and using the mobile phone terminal (22) of the user (20) capable of wireless internet to directly connect to the personalized internet phone service web server (10) and store the phone number in the personal phone number directory storage database (12).

4. The method of claim 2, wherein the additionally provided phone number in operation S13 is selected and set by the wired/wireless internet phone terminal (21) of the user (20), from among a provided phone number according to an area of interest to the user (20) or a current location of the user (20) which are stored in an additionally provided phone number directory storage database (13) of the personalized internet phone service web server (10), and a provided phone number of a venue conducting a phone rate discount and gift event; and the phone number providing sequence is selected and set by the wired/wireless internet phone terminal (21) of the user (20), from among a free phone number sequence according to a receiver billing policy, a free phone number sequence according to a billing policy of an internet phone service provider to which the wired/wireless phone terminal (21) used by the user (20) is registered, and a phone number sequence of an inexpensive telecom rate.

5. The method of claim 2, wherein in the personal authentication method of operation S14, when required information is input for an authentication method using an ID (user mobile phone number/text/numbers) and a set security number, or for an authentication method using text messaging of an authentication number to the mobile phone of the user (20), or for an authentication method using a digital certificate and digital certificate security number of the user (20), or for an authentication method using a credit card and credit card security number of the user (20), one of the authentication methods is selected as a standard authentication method.

6. The method of claim 2, wherein the payment method in operation S15 is selected as a standard payment method from among a method of billing to a mobile phone bill or telecom bill of the user (20), a method of billing to a credit card bill of the user (20), and a method of issuing a bill by mail to the user (20) or automatic payment.

7. The method of claim 1, wherein in operation S20, the connection is made to the personalized internet phone service web server (10) through wired/wireless internet, by means of:
directly clicking an internet phone service execute menu button provided in a button format on an outside of the wired/wireless internet phone terminal (21) or an execute menu button having a number code provided in a touch screen format on a screen of the wired/wireless internet phone terminal (21) that selectively uses one from among a home phone, office phone, internet public phone, and a mobile communication terminal having an application installed therein provided by the personalized internet phone service web server (10); or
inputting a number code corresponding to one provided on the screen of the wired/wireless internet phone terminal (21), through an external number pad on a phone.

8. The method of claim 1, wherein in operation S30, text/number buttons in a touch screen format provided on a screen or external text/number buttons on the wired/wireless internet phone terminal (21) that connects to and uses the personalized internet phone service web server (10) are clicked to select a standard authentication method set upon registration or another authentication number and log in, a standard payment method for the phone bill of the internet phone to be used, or another payment method is selected, and the payment method is billed as a standard billing for the wired/wireless internet phone terminal (21) being used when the billing method is not selected.

9. The method of claim 1, wherein operation S40 comprises operations:
(S41) of activating, in a display screen of the wired/wireless internet phone terminal (21), a ‘personal phone number call service’ menu for calling a phone number list stored by a user (20) upon registration, from the personal phone number directory storage database (12), and an ‘additional service’ menu provided by an additionally provided phone number directory storage database (13) for phone numbers corresponding to conditions set by the user (20) upon registration to be additionally received;
(S42) of using buttons of the wired/wireless internet phone terminal (21) to select a menu to be received from among the ‘personal phone number call service’ menu and the ‘additional service’ menu, to call a personal phone number or receive an additional service phone number;
(S43) of activating the group menu initially stored in the mobile phone terminal (22) of the user, when the ‘personal phone number call service’ is selected, and activating a group menu by company for an area of interest or the current location, when the ‘additional service’ is selected;
(S44) of arranging phone numbers of corresponding counterparts when the ‘personal phone number call service’ group is selected, in a stored sequence in the mobile phone terminal (22) of the user (20), and arranging phone numbers of corresponding businesses when the ‘additional service’ group is selected, in an order of priority from free calling and least expensive telecom rates from among a recipient billing policy and an internet phone service provider billing policy under which the wired/wireless internet phone terminal (21) used by the user (20) is registered; and
(S45) of connecting a call after selection of a phone number to be called from among a phone number called by means of the ‘personal phone number call service’ and a phone number provided by the ‘additional service’, and connecting a call by selecting one from among a method for connecting a call by the user (20) searching for a phone number to call through sub categories in a tree method, through a menu having a number code configured on the screen of the wired/wireless internet phone terminal (21) with external number buttons, and a method for connecting a call by searching for a number of a corresponding group or counterpart (30) by the user (20), in the search screen of the wired/wireless internet phone terminal (21), with text and partial numbers of phone numbers thereof.

10. The method of claim 1, wherein in operation S50, before and after a call connection is made for a new number not called or provided by the personal phone number directory storage database (12) of the personalized internet phone service web server (10), a ‘save new’ menu button provided on a screen of the wired/wireless internet phone terminal (21) is activated, and the new number is newly stored in the phone number list stored in the personal phone number directory storage database (12) of the personalized internet phone service web server (10).

11. The method of claim 1, wherein whenever use of the wired/wireless internet phone terminal (21) is ended, a time a call was made by the user (20), a number with which the call was connected, a call time, a call rate, and a call rate billing method are automatically stored in the personal information storage database (11) of the personalized internet phone service web server (10), the details of use are automatically sent by e-mail to an e-mail address entered when the user (20) registered in the personalized internet phone service web server (10) or automatically sent by text message to the mobile phone terminal (22) of the user (20), and the user (20) is able to check the details of use by logging into the personalized internet phone service web server (10).

12. The method of claim 1, wherein when the wired/wireless internet phone terminal (21) is used to log into the personalized internet phone service web server (10), or when after a certain time has elapsed since the wired/wireless internet phone terminal (21) was used to make a phone call and there is no subsequent input signal through a button, or when the user (20) lowers a receiver or selects a forcibly ending menu button in the wired/wireless phone terminal (21), the personalized internet phone service web server (10) perceives an end signal by the user (20) and automatically logs out.

13. The method of claim 1, wherein the wired/wireless internet phone terminal (21) comprises a speech calling member that connects directly to a computer terminal.

14. A personalized internet phone service provided through a method of claim 1.
